(19) United States
(12) Patent Application Publication
(10) Pub. No.: US 2024/0014972 A1
(43) Pub. Date: Jan. 11, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 18/042,117

(22) PCT Filed: Aug. 17, 2021
(86) PCT No.: PCT/JP2021/030021

§ 371 Date: Feb. 17, 2023

(30) Foreign Application Priority Data
Aug. 20, 2020 (JP) 2020-139403

(51) Int. Cl. H04L 5/00; H04W 72/232; H04W 72/0446

(52) U.S. Cl. CPC H04L 5/0051; H04W 72/232; H04W 72/0446

(57) ABSTRACT

A terminal according to an aspect of the present disclosure includes: a reception section that receives a configuration indicating an uplink period and a downlink period and receives a slot offset for aperiodic sounding reference signal (SRS) transmission; and a control section that determines whether or not to receive at least one of a first piece of downlink control information that triggers the SRS transmission and a second piece of downlink control information indicating a slot format. According to an aspect of the present disclosure, SRS transmission is flexibly controlled.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). In addition, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+ (plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In NR, the use of a sounding reference signal (SRS) is being studied.

However, studies on the control of SRS transmission are not in progress. If SRS transmission is not flexibly configured, resource use efficiency, communication throughput, communication quality, etc. may be degraded.

Thus, an object of the present disclosure is to provide a terminal, a radio communication method, and a base station that flexibly control SRS transmission.

### Solution to Problem

A terminal according to an aspect of the present disclosure includes: a reception section that receives a configuration indicating an uplink period and a downlink period and receives a slot offset for aperiodic sounding reference signal (SRS) transmission; and a control section that determines whether or not to receive at least one of a first piece of downlink control information that triggers the SRS transmission and a second piece of downlink control information indicating a slot format.

### Advantageous Effects of Invention

According to an aspect of the present disclosure, SRS transmission can be flexibly controlled.

### BRIEF DESCRIPTION OF DRAWINGS

FIG. 1 is a diagram illustrating an example of a slot offset for A-SRS transmission.

FIG. 2 is a diagram illustrating Example 1 of a relationship between pieces of DCI #1 and #2.

FIG. 3 is a diagram illustrating Example 2 of a relationship between pieces of DCI #1 and #2.

FIG. 4 is a diagram illustrating Example 3 of a relationship between pieces of DCI #1 and #2.

FIG. 5 is a diagram illustrating an example of a schematic configuration of a radio communication system according to an embodiment.

FIG. 6 is a diagram illustrating an example of a configuration of a base station according to an embodiment.

FIG. 7 is a diagram illustrating an example of a configuration of a user terminal according to an embodiment.

FIG. 8 is a diagram illustrating an example of a hardware configuration of a base station and a user terminal according to an embodiment.

### DESCRIPTION OF EMBODIMENTS

(SRS)

In the NR, a sounding reference signal (SRS) has a wide range of usages. The SRS of the NR is used not only for uplink (UL) CSI measurement also used in existing LTE (LTE Rel. 8 to 14) but also for downlink (DL) CSI measurement, beam management and the like.

In the UE, one or a plurality of SRS resources may be configured. The SRS resource may be specified by an SRS resource index (SRI).

Each SRS resource may include one or a plurality of SRS ports (may correspond to one or a plurality of SRS ports). For example, the number of ports of each SRS may be one, two, four and the like.

For a UE, one or more SRS resource sets may be configured. One SRS resource set may be associated with a given number of SRS resources. The UE may commonly use a higher layer parameter for the SRS resources included in one SRS resource set. Note that, in the present disclosure, the resource set may be replaced with a set, a resource group, a group and the like.

Information regarding the SRS resources or resource set may be configured in the UE by using higher layer signaling, physical layer signaling, or a combination thereof.

Note that in the present disclosure, the higher layer signaling may be, for example, any one of radio resource control (RRC) signaling, medium access control (MAC) signaling, broadcast information, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), other system information (OSI), or the like.

The physical layer signaling may be, for example, Downlink Control Information (DCI).

The SRS configuration information (for example, an RRC information element “SRS-Config”) may include SRS resource set configuration information, SRS resource configuration information and the like.

The SRS resource set configuration information (e.g., the RRC parameter “SRS-ResourceSet”) may include information on an SRS resource set identifier (ID) (SRS-ResourceSetId), a list of SRS resource IDs (SRS-ResourceId) used in the resource set, an SRS resource type (resourceType), and SRS usage (usage).

Here, the SRS resource type may indicate a behavior in the time domain of an SRS resource configuration (same time domain behavior), and may indicate any one of a periodic SRS (P-SRS), a semi-persistent SRS (SP-SRS), and an aperiodic SRS (A-SRS). Note that the UE may transmit the P-SRS and SP-SRS periodically (or periodically after activation). The UE may transmit the A-SRS based on the SRS request of the DCI.

In addition, the application of SRS (“usage” of the RRC parameter and “SRS-SetUse” of the L1 (Layer-1) parameter) may be, for example, beam management (beamManagement), codebook (CB), non-codebook (NCB), antenna switching (antennaSwitching), or the like. For example, an SRS used for codebook or non-codebook may be used to determine a precoder for codebook-based or non-codebook-based physical uplink shared channel (PUSCH) transmission based on an SRI.

For an SRS used for beam management, it may be assumed that only one SRS resource per SRS resource set can be transmitted at a predetermined time instant (given time instant). Note that, in a case where, in the same bandwidth part (BWP), a plurality of SRS resources falling under the same behavior in the time domain belong to different SRS resource sets, these SRS resources may be simultaneously transmitted.

The SRS resource configuration information (e.g., the RRC parameter “SRS-Resource”) may include an SRS resource ID (SRS-ResourceId), the number of SRS ports, the SRS port numbers, a transmission comb, SRS resource mapping (such as a time and/or frequency resource position, a resource offset, a resource period, the number of repetitions, the number of SRS symbols, an SRS bandwidth, etc.), hopping-related information, an SRS resource type, a sequence ID, spatial relation information, etc.

The UE may switch a bandwidth part (BWP) to transmit an SRS or may switch antennas slot by slot. Furthermore, the UE may apply at least one of in-slot hopping and inter-slot hopping to the SRS transmission.

(A-SRS Triggering)

An SRS request field for triggering an A-SRS is included in, for example, DCI format 0_1, 0_2, 1_1, 1_2, or 2_3.

Among the values (code points) of a 2-bit SRS request field, three values of 01, 10, and 11 other than the value 00 are associated with (mapped to) one or more SRS resource sets.

The size of an SRS request field in DCI format 0_2 or 1_2 may be 0, 1, 2, or 3 bits. Among the values (code points) of a 1-bit SRS request field, the value 1 is associated with (mapped to) one or more SRS resource sets.

The time between a trigger of an A-SRS and SRS transmission is a value k (slot offset) configured by RRC.

An SRS resource set information element (SRS-ResourceSet) includes, for an A-SRS, a slot offset (slotOffset) and an A-SRS resource trigger list (aperiodicSRS-ResourceTriggerList). That is, the slot offset and the A-SRS resource trigger list are configured for each SRS resource set. In a case where a slot offset is not configured, the UE applies no offset (value 0). The A-SRS resource trigger list includes one or more A-SRS resource trigger (aperiodicSRS-ResourceTrigger) information elements (states and IDs). The A-SRS resource trigger indicates a DCI code point by which an SRS is transmitted in accordance with an SRS resource set configuration including the A-SRS resource trigger.

A scheme in which a slot offset is dynamically indicated/configured by using DCI or a MAC CE is being studied.

Further, a scheme in which a slot offset k (0 to 7) configured by higher layer signaling is redefined as the (k+1)-th available (valid, or available for UL) slot, that is, DL slots are not counted in a slot offset is being studied.

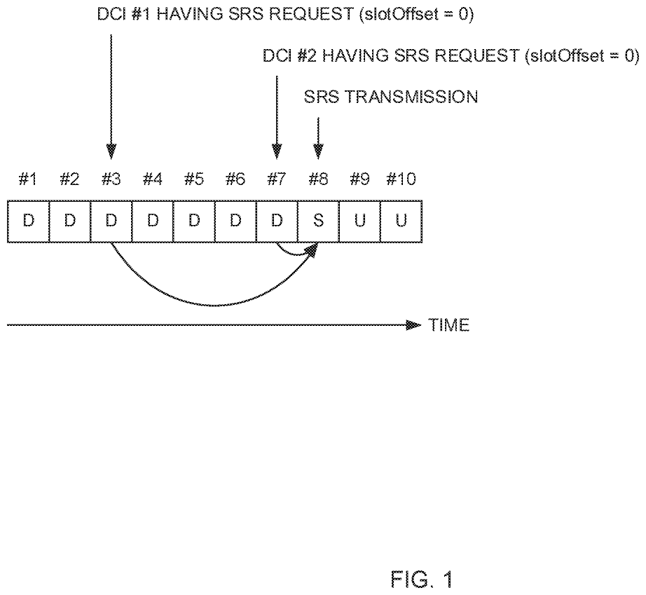

In the example of FIG. 1, slots #1 to #7 are DLs, slot #8 is a slot including a DL symbol and a UL symbol (for example, a special slot), and slots #9 to #10 are ULs. The slot offset k is set to 0, DCI #1 with an SRS request is received in slot #3, and DCI #2 with an SRS request is received in slot #3. The slot of SRS transmission is the first available slot after DCI; hence, both the slot of SRS transmission for DCI #1 and the slot of SRS transmission for DCI #2 are slot #8.

By using this slot offset, appropriate indication can be made even in an 8:2 DL-UL slot configuration with many DL slots.

On the other hand, in NR, a UL/DL slot (slot format) may be dynamically indicated by DCI (a slot format indicator (SFI)). This DCI may be group-common signaling (a group-common PDCCH, or DCI format 2_0). One or more combinations (SlotFormatCombination) are configured by higher layer signaling, and each combination includes one or more slot formats. The SFI indicates a combination. The slot format indicates DL, UL, or flexibility of each symbol in one slot. This DCI includes one or more SFIs.

For such a slot format, it is preferable to flexibly control SRS transmission.

If SRS transmission is not flexibly controlled, resource use efficiency, communication throughput, communication quality, etc. may be degraded.

Thus, the present inventors have conceived a method of flexibly controlling SRS transmission.

Hereinafter, embodiments according to the present disclosure will be described in detail with reference to the drawings. The radio communication method according to each of the embodiments may be applied independently, or may be applied in combination with others.

In the present disclosure, “A/B” and “at least one of A or B” may be interchangeable. In the present disclosure, the cell, the serving cell, the CC, the carrier, the BWP, the DL BWP, the UL BWP, the active DL BWP, the active UL BWP, and the band may be replaced with each other. In the present disclosure, an index, an ID, an indicator, and a resource ID may be read as interchangeable with each other. In the present disclosure, an RRC, an RRC parameter, an RRC message, a higher layer parameter, an information element (IE), and a configuration may be read as interchangeable with each other. In the present disclosure, “support”, “control”, “control”, “operate”, and “operable” may be replaced with each other. In the present disclosure, a sequence, a list, a set, and a group may be replaced with each other. In the present disclosure, mapping, association, a relationship, and a table may be replaced with each other.

In the present disclosure, “activate”, “update”, “indicate”, “enable”, “specify”, and “change” may be replaced with each other.

In the present disclosure, a MAC CE, an updating command, and an activation/deactivation command may be replaced with each other.

In the present disclosure, the higher layer signaling may be any of, for example, radio resource control (RRC) signaling, medium access control (MAC) signaling, broadcast information, and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), other system information (OSI), or the like.

In the present disclosure, a semi-static configuration of UL/DL slots, a UL/DL TDD configuration, a cell-specific UL/DL TDD configuration (TDD-UL-DL-ConfigCommon), a UE-specific UL/DL TDD configuration (TDD-UL-DL-ConfigDedicated), a DL-UL pattern, and a configuration indicating a UL period and a DL period may be replaced with each other. In the present disclosure, UL/DL slot updating, slot format application, and SFI application may be replaced with each other.

(Radio Communication Method)

The UE may support a specific function in which a slot offset k configured by higher layer signaling is interpreted as the (k+1)-th available (valid, or available for UL) slot (DL slots are not counted in a slot offset). In a slot available for UL, at least some symbols may be ULs. A UE using the specific function may regard the slot offset as the number of slots available for UL. A UE not using the specific function may regard the slot offset as the number of slots.

The UE may determine whether or not to receive at least one of a first piece of DCI that triggers SRS transmission and a second piece of DCI indicating a slot format.

In the present disclosure, the first piece of DCI, DCI format 0_1, 0_2, 1_1, 1_2, or 2_3, and DCI including an SRS request may be replaced with each other. In the present disclosure, the second piece of DCI, DCI format 2_0, and DCI including an SFI may be replaced with each other.

### First Embodiment

A higher layer parameter that configures the specific function may be prescribed. In a case where a higher layer parameter corresponding to the specific function is configured, the UE may apply (enable) the specific function. In a case where a higher layer parameter corresponding to the specific function is not configured, the UE may not apply (enable) the specific function.

According to the first embodiment described above, a slot offset can be flexibly controlled while compatibility with Rel. 15/16 is kept.

### Second Embodiment

The specific function may be applied to a semi-static configuration of UL/DL slots.

The specific function may not be applied to a dynamic configuration of UL/DL slots. In a case where the UE applies the specific function, the UE may not assume that a slot format is indicated by an SFI (DCI).

In a case where UL/DL slots are semi-statically configured, the UE may use the specific function (may recognize a slot offset by counting slots in which UL transmission is possible). Otherwise (for example, in a case where a slot format is indicated by an SFI), the UE may not use the specific function (may recognize a slot offset by counting the number of slots (absolute slot indices)).

According to the second embodiment described above, a slot offset can be flexibly controlled.

### Third Embodiment

The specific function may be applied to a dynamic configuration of UL/DL slots. In a case where the UE applies the specific function, the UE may assume that a slot format is indicated by an SFI (DCI). The specific function may be applied to a semi-static configuration of UL/DL slots.

A relationship between DCI #1 (the first piece of DCI) that triggers an A-SRS and DCI #2 (the second piece of DCI) indicating an SFI may be prescribed. The UE may, on the basis of a reception timing of one of pieces of DCI #1 and #2, determine whether or not to receive the other of pieces of DCI #1 and #2. The relationship between pieces of DCI #1 and #2 may conform to at least one of relations 0, 0a, 1, and 2 below.

<<Relation 0>>

The UE may not assume that DCI #2 is received in the period from DCI #1 reception to A-SRS transmission.

One piece of DCI #3 may include a first field indicating A-SRS transmission and a second field indicating an SFI. In the period from DCI #1 reception to A-SRS transmission, the UE may receive DCI #3 (may be dynamically instructed of a slot format by DCI #3).

<<Relation 0a>>

In a case where the UE receives DCI #2 in the period from DCI #1 reception to A-SRS transmission, the UE may update the slot format in accordance with DCI #2 after a specific period of time elapses from the A-SRS transmission. The specific period of time may be any of K symbols, K slots, and K [ms].

The specific period of time (K) may be prescribed by specifications, may be reported as UE capability by the UE, or may be configured by higher layer signaling.

<<Relation 1>>

The UE may not assume that DCI #1 is received before DCI #2 (in the time domain). The UE may assume that DCI #2 is always received before DCI #1. The UE may not assume that, after A-SRS transmission is triggered, UL/DL slots are dynamically switched (a slot format is dynamically applied).

In a case where a first period from DCI #1 reception to A-SRS transmission and a second period from DCI #2 reception to UL/DL slot updating overlap for a minimum period of time or more, the UE may assume that DCI #2 is always received before DCI #1. The minimum period of time may be either of one symbol and one slot.

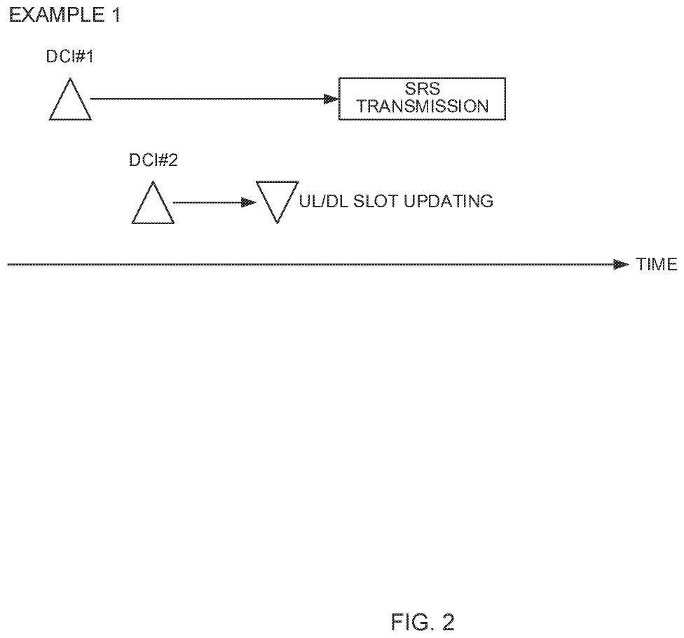

The UE may not assume that the UL/DL slot updating timing is before A-SRS transmission (is in the period from a trigger of A-SRS transmission to the A-SRS transmission). In Example 1 of FIG. 2, the first period from DCI #1 reception to A-SRS transmission based on the DCI #1 reception includes DCI #2 reception and UL/DL slot updating based on the DCI #2 reception. The UE may not assume the case of Example 1.

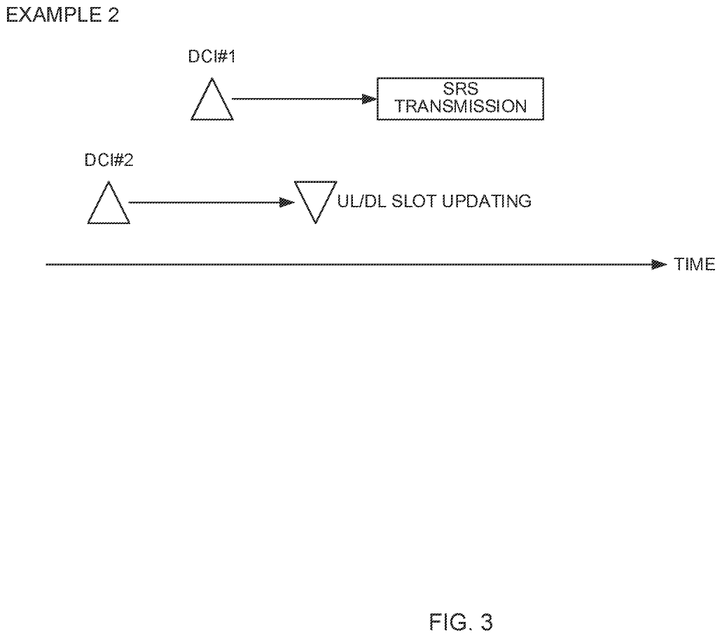

The UE may receive a trigger of A-SRS transmission in a state of recognizing subsequent UL/DL slot updating. In other words, the UE may receive DCI #1 after DCI #2. In Example 2 of FIG. 3, the UE receives DCI #1 in the second period from DCI #2 reception to UL/DL slot updating based on the DCI #2 reception. The UE may assume the case of Example 2.

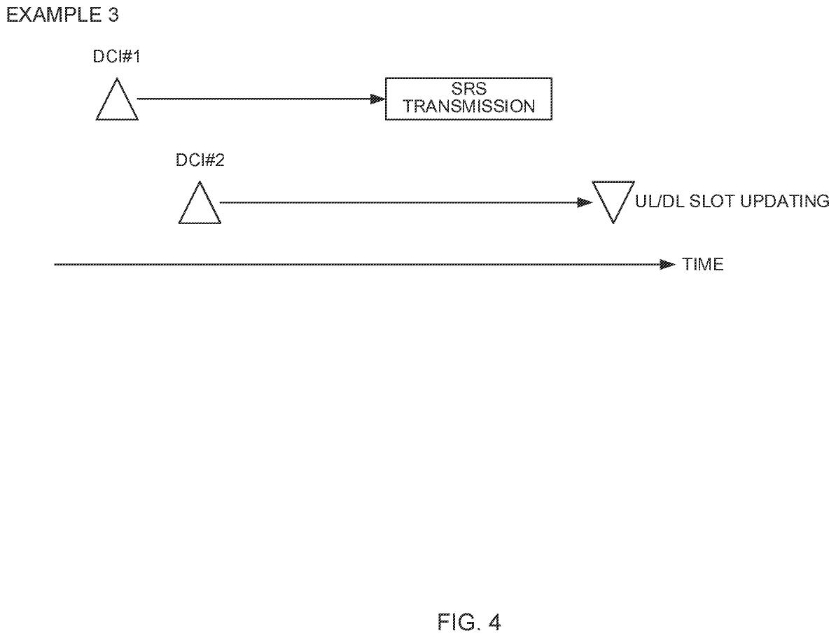

The UE may not assume that UL/DL slot updating is applied after A-SRS transmission. In Example 3 of FIG. 4, DCI #2 is received in the first period from DCI #1 reception to A-SRS transmission based on the DCI #1 reception, and UL/DL slot updating based on DCI #2 is applied after the A-SRS transmission. The UE may not assume the case of Example 3.

<<Relation 2>>

In a case where DCI #1 is received before DCI #2 (in particular, in the case of Example 1), the UE may conform to either one of operations 1 and 2 below.

### [Operation 1]

The UE may trigger A-SRS transmission on the basis of the indication/configuration of UL/DL slots of the time of DCI #1 reception. In a case where a specific slot in which the UE intends to perform A-SRS transmission triggered by DCI #1 is, at the time of DCI #1 reception, a slot in which UL transmission is possible and yet is, at the time when the UE is about to perform the A-SRS transmission, no longer a slot in which UL transmission is possible, the UE may not perform the A-SRS transmission.

### [Operation 2]

The UE may determine a slot (timing) of A-SRS transmission triggered by DCI #1 on the basis of the indication/configuration of UL/DL slots of the time when the UE is about to perform the A-SRS transmission. When the assumption of UL/DL slots is switched by DCI #2, the UE may change the slot of A-SRS transmission in accordance with the switching.

There may be a case where it is difficult for the UE to change (stop) the timing of A-SRS transmission immediately before the A-SRS transmission. A time offset (threshold) from DCI #2 reception to A-SRS transmission triggered by DCI #1 may be prescribed. In a case where the time offset from DCI #2 reception to A-SRS transmission triggered by DCI #1 is shorter than (or not more than) a time offset threshold, the UE may not perform the A-SRS transmission. In a case where the time offset from DCI #2 reception to A-SRS transmission triggered by DCI #1 is shorter than the time offset threshold (or is not more than the time offset threshold), the UE may not perform the A-SRS transmission. In a case where the time offset from DCI #2 reception to A-SRS transmission triggered by DCI #1 is not less than the time offset threshold (or is longer than the time offset threshold), the UE may perform the A-SRS transmission.

The time offset threshold may be prescribed in specifications, may be reported as UE capability by the UE, or may be configured by higher layer signaling. A time offset threshold, a threshold, and duration may be replaced with each other. The time offset threshold may be any of T slots, T symbols, and T [ms].

<<Modification>>

The UE may need decoding time (processing time) from the reception of DCI to the decoding of the DCI. The time (time point) of DCI (#1/#2) reception described above may be read as a time point when the decoding time has elapsed from the DCI reception. The decoding time may be the time required for decoding of DCI. The decoding time may be either of M symbols and M [μs].

The decoding time (M) may be prescribed in specifications, may be reported as UE capability by the UE, or may be configured by higher layer signaling.

According to the third embodiment described above, at least one of a slot offset and a slot format can be flexibly controlled.

### Fourth Embodiment

UE capability corresponding to at least one function in the first to third embodiments may be prescribed. The UE capability may indicate that the UE supports this function. In a case where the UE has reported the UE capability, the UE may perform the corresponding function. In a case where the UE has reported the UE capability and is configured with a higher layer parameter corresponding to this function, the UE may perform the corresponding function.

A higher layer parameter (RRC information element) corresponding to at least one function in the first to third embodiments may be prescribed. In a case where the higher layer parameter is configured, the UE may perform the corresponding function.

According to the fourth embodiment described above, a slot offset can be flexibly controlled while compatibility with Rel. 15/16 is kept.

(Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

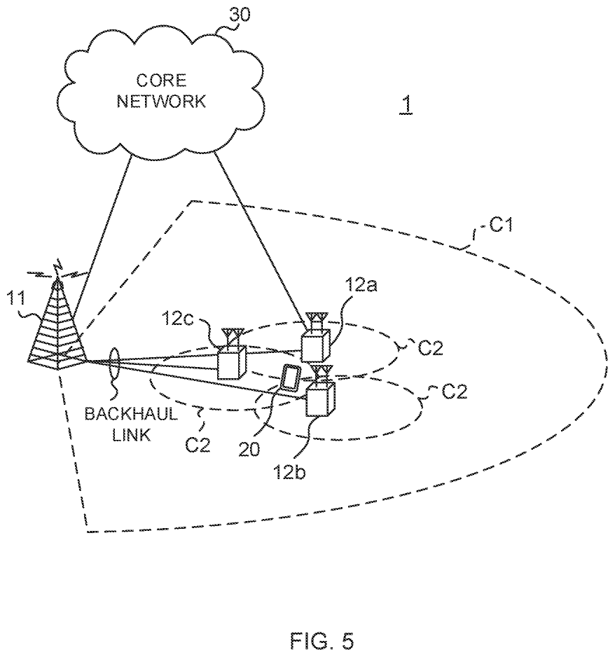

FIG. 5 is a diagram illustrating an example of a schematic configuration of a radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is the MN, and an LTE (E-UTRA) base station (eNB) is the SN.

The radio communication system 1 may support dual connectivity between a plurality of base stations in the same RAT (for example, dual connectivity in which both the MN and the SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a frequency range 1 (FR1) or a frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency bands, definitions, and the like of the FR1 and FR2 are not limited thereto, and, for example, the FR1 may correspond to a frequency band higher than the FR2.

Further, the user terminal 20 may perform communication in each CC using at least one of time division duplex (TDD) or frequency division duplex (FDD).

The plurality of base stations 10 may be connected by wire (e.g., an optical fiber or an X2 interface in compliance with common public radio interface (CPRI)) or wirelessly (e.g., NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), or a next generation core (NGC).

The user terminal 20 may a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH), a physical broadcast channel (PBCH), a physical downlink control channel (PDCCH), or the like shared by the user terminals 20 may be used.

Further, in the radio communication system 1, as an uplink channel, a physical uplink shared channel (PUSCH), a physical uplink control channel (PUCCH), a physical random access channel (PRACH), or the like shared by the user terminals 20 may be used.

User data, higher layer control information, a system information block (SIB), and the like are transmitted on the PDSCH. The PUSCH may transmit the user data, higher layer control information, and the like. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH or the PUSCH.

Note that the DCI that schedules the PDSCH may be referred to as DL assignment, DL DCI, or the like, and the DCI that schedules PUSCH may be referred to as UL grant, UL DCI, or the like. Note that the PDSCH may be replaced with DL data, and the PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. The UE may monitor the CORESET associated with a certain search space based on search space configuration.

One search space may correspond to a PDCCH candidate corresponding to one or more aggregation levels. One or more search spaces may be referred to as a search space set. Note that “search space” and “search space set”, “search space configuration” and “search space set configuration”, and “CORESET” and “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), or scheduling request (SR) may be transmitted on the PUCCH. A random access preamble for establishing connection with a cell may be transmitted on the PRACH.

Note that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals).”

(Base Station)

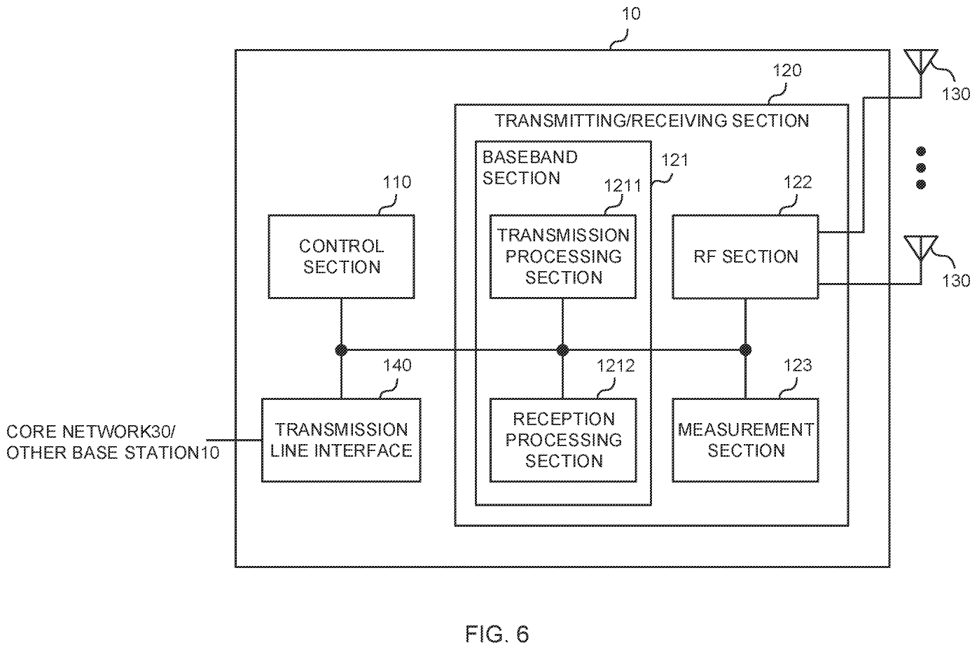

FIG. 6 is a diagram illustrating an example of a configuration of the base station according to one embodiment. The base station 10 includes a control section 110, a transmission/reception section 120, a transmission/reception antenna 130, and a transmission line interface 140. Note that one or more control sections 110, one or more transmission/reception sections 120, one or more transmission/reception antennas 130, and one or more transmission line interfaces 140 may be included.

Note that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be implemented by a controller, a control circuit, and the like that are described based on common recognition in the technical field related to the present disclosure.

The control section 110 may control signal generation, scheduling (for example, resource allocation or mapping), and the like. The control section 110 may control transmission/reception, measurement, and the like using the transmission/reception section 120, the transmission/reception antenna 130, and the transmission line interface 140. The control section 110 may generate data to be transmitted as a signal, control information, a sequence, and the like, and may forward the data, the control information, the sequence, and the like to the transmission/reception section 120. The control section 110 may perform call processing (such as configuration or releasing) of a communication channel, management of the state of the base station 10, and management of a radio resource.

The transmission/reception section 120 may include a baseband section 121, a radio frequency (RF) section 122, and a measurement section 123. The baseband section 121 may include a transmission processing section 1211 and a reception processing section 1212. The transmission/reception section 120 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmission/reception section 120 may be configured as an integrated transmission/reception section, or may be configured by a transmission section and a reception section. The transmission section may include the transmission processing section 1211 and the RF section 122. The reception section may be implemented by the reception processing section 1212, the RF section 122, and the measurement section 123.

The transmission/reception antennas 130 can be implemented by antennas described based on common recognition in the technical field related to the present disclosure, for example, an array antenna.

The transmission/reception section 120 may transmit the above-described downlink channel, synchronization signal, downlink reference signal, and the like. The transmission/reception section 120 may receive the above-described uplink channel, uplink reference signal, and the like.

The transmission/reception section 120 may form at least one of a Tx beam or a reception beam by using digital beam forming (for example, precoding), analog beam forming (for example, phase rotation), and the like.

The transmission/reception section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmission/reception section 120 (transmission processing section 1211) may perform transmission processing such as channel encoding (which may include error correcting encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmission/reception section 120 (RF section 122) may perform modulation to a radio frequency band, filtering processing, amplification, and the like on the baseband signal, and may transmit a signal in the radio frequency band via the transmission/reception antenna 130.

Meanwhile, the transmission/reception section 120 (RF section 122) may perform amplification, filtering processing, demodulation to a baseband signal, and the like on the signal in the radio frequency band received by the transmission/reception antenna 130.

The transmission/reception section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmission/reception section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, another base stations 10, and the like, and may acquire, transmit, and the like user data (user plane data), control plane data, and the like for the user terminal 20.

Note that the transmission section and the reception section of the base station 10 in the present disclosure may include at least one of the transmission/reception section 120, the transmission/reception antenna 130, or the transmission line interface 140.

The transmission/reception section 120 may transmit a configuration indicating an uplink period and a downlink period, and may transmit a slot offset for aperiodic sounding reference signal (SRS) transmission. The control section 110 may determine whether or not to transmit at least one of a first piece of downlink control information that triggers the SRS transmission and a second piece of downlink control information indicating a slot format.

(User Terminal)

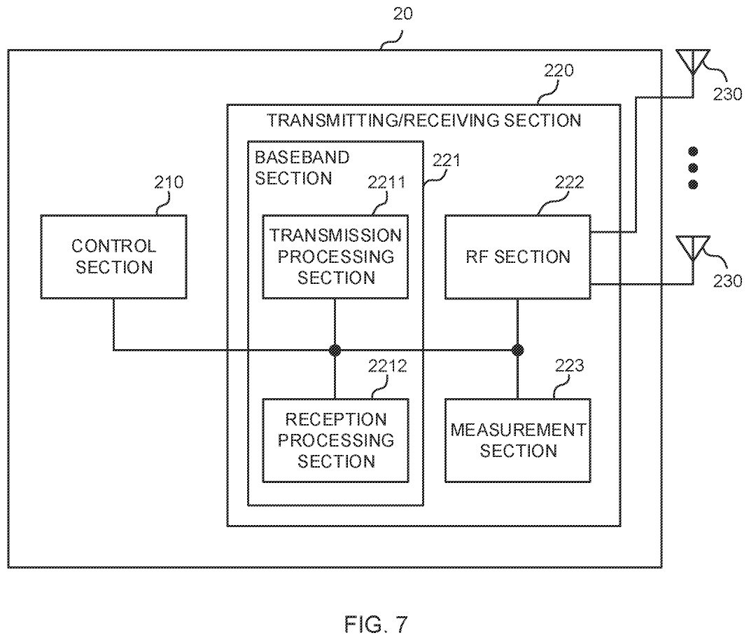

FIG. 7 illustrates an example of a configuration of the user terminal according to one embodiment. The user terminal 20 includes a control section 210, a transmission/reception section 220, and a transmission/reception antenna 230. Note that one or more of the control sections 210, one or more of the transmission/reception sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described on the basis of common recognition in the technical field related to the present disclosure.

The control section 210 may control signal generation, mapping, and the like. The control section 210 may control transmission/reception, measurement, and the like using the transmission/reception section 220 and the transmission/reception antenna 230. The control section 210 may generate data, control information, a sequence, and the like to be transmitted as signals, and may forward the data, control information, sequence, and the like to the transmission/reception section 220.

The transmission/reception section 220 may include a baseband section 221, an RF section 222, and a measurement section 223. The baseband section 221 may include a transmission processing section 2211 and a reception processing section 2212. The transmission/reception section 220 can be implemented by a transmitter/receiver, an RF circuit, a baseband circuit, a filter, a phase shifter, a measurement circuit, a transmission/reception circuit, and the like that are described based on common recognition in the technical field related to the present disclosure.

The transmission/reception section 220 may be formed as an integrated transmission/reception section, or may include a transmission section and a reception section. The transmission section may include the transmission processing section 2211 and the RF section 222. The reception section may include the reception processing section 2212, the RF section 222, and the measurement section 223.

The transmission/reception antenna 230 can include an antenna described on the basis of common recognition in the technical field related to the present disclosure, for example, an array antenna.

The transmission/reception section 220 may receive the above-described downlink channel, synchronization signal, downlink reference signal, and the like. The transmission/reception section 220 may transmit the above-described uplink channel, uplink reference signal, and the like.

The transmission/reception section 220 may form at least one of a Tx beam or a reception beam by using digital beam forming (for example, precoding), analog beam forming (for example, phase rotation), and the like.

The transmission/reception section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmission/reception section 220 (transmission processing section 2211) may perform transmission processing such as channel encoding (which may include error correcting encoding), modulation, mapping, filtering processing, DFT processing (if necessary), IFFT processing, precoding, or digital-analog conversion on the bit string to be transmitted, to output a baseband signal.

Note that whether or not to apply DFT processing may be determined based on configuration of transform precoding. In a case where transform precoding is enabled for a certain channel (e.g., PUSCH), the transmission/reception section 220 (transmission processing section 2211) may perform DFT processing as the transmission processing in order to transmit the channel using a DFT-s-OFDM waveform. In a case where it is not the case, DFT processing need not be performed as the transmission processing.

The transmission/reception section 220 (RF section 222) may perform modulation to a radio frequency range, filtering processing, amplification, and the like on the baseband signal, to transmit a signal in the radio frequency range via the transmission/reception antenna 230.

Meanwhile, the transmission/reception section 220 (RF section 222) may perform amplification, filtering processing, demodulation to a baseband signal, and the like on the signal in the radio frequency range received by the transmission/reception antenna 230.

The transmission/reception section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmission/reception section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmission section and the reception section of the user terminal 20 in the present disclosure may include at least one of the transmission/reception section 220 or the transmission/reception antenna 230.

The transmission/reception section 220 may receive a configuration indicating an uplink period and a downlink period, and may receive a slot offset for aperiodic sounding reference signal (SRS) transmission. The control section 210 may determine whether or not to receive at least one of a first piece of downlink control information that triggers the SRS transmission and a second piece of downlink control information indicating a slot format.

In a case where a higher layer parameter is configured, the control section 210 may regard the slot offset as the number of slots available for uplinks.

The control section 210 may assume that the second piece of downlink control information is not received, and may regard the slot offset as the number of slots available for uplinks.

The control section 210 may, on the basis of a reception timing of one of the first piece of downlink control information and the second piece of downlink control information, determine whether or not to receive the other of the first piece of downlink control information and the second piece of downlink control information.

(Hardware Configuration)

Note that the block diagrams that have been used to describe the above embodiments illustrate blocks in functional units. These functional blocks (components) may be implemented in arbitrary combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be realized by combining the one apparatus or the plurality of apparatuses with software.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmission section (transmitting unit), a transmitter, and the like. In any case, as described above, the implementation method is not particularly limited.

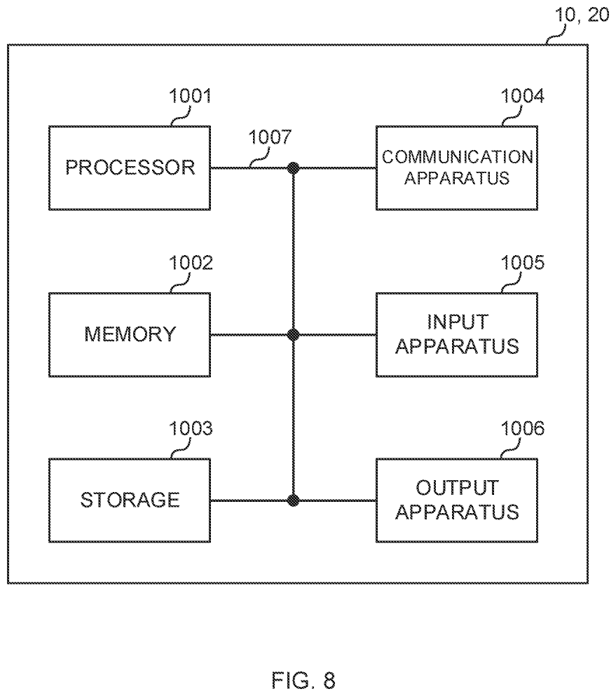

For example, the base station, the user terminal, and the like according to one embodiment of the present disclosure may function as a computer that executes the processing of the radio communication method of the present disclosure. FIG. 8 illustrates an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit can be replaced with each other. The hardware configuration of the base station 10 and the user terminal 20 may be designed to include one or more of the apparatuses illustrated in the drawings, or may be designed not to include some apparatuses.

For example, although only one processor 1001 is shown, a plurality of processors may be provided. Further, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by predetermined software (program) being read on hardware such as the processor 1001 and the memory 1002, by which the processor 1001 performs operations, controlling communication via the communication apparatus 1004, and controlling at least one of reading or writing of data at the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least a part of the above-described control section 110 (210), transmission/reception section 120 (220), and the like may be implemented by the processor 1001.

The processor 1001 reads programs (program codes), software modules, data, etc. from at least one of the storage 1003 or the communication apparatus 1004 into the memory 1002, and performs various types of processing according to these. As the program, a program that causes a computer to execute at least a part of the operation described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store programs (program codes), software modules, etc. that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus.”

The communication apparatus 1004 is hardware (transmission/reception device) for performing inter-computer communication via at least one of a wired network or a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmission/reception section 120 (220), the transmission/reception antenna 130 (230), and the like described above may be implemented by the communication apparatus 1004. The transmission/reception section 120 (220) may be implemented by being physically or logically separated into the transmission section 120a (220a) and the reception section 120b (220b).

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented with at least one of these pieces of hardware.

(Modification)

Note that terms described in the present disclosure and terms necessary for understanding the present disclosure may be replaced with terms that have the same or similar meanings. For example, a channel, a symbol, and a signal (signal or signaling) may be replaced with each other. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may be comprised of one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, or specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

The slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) transmitted using a mini slot may be referred to as PDSCH (PUSCH) mapping type B.

A radio frame, a subframe, a slot, a mini slot and a symbol all represent the time unit in signal communication. The radio frame, the subframe, the slot, the mini slot, and the symbol may be called by other applicable names, respectively. Note that time units such as a frame, a subframe, a slot, a mini slot, and a symbol in the present disclosure may be replaced with each other.

For example, one subframe may be referred to as TTI, a plurality of consecutive subframes may be referred to as TTI, or one slot or one mini slot may be referred to as TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot” and so on, instead of a “subframe.”

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be a transmission time unit of a channel-coded data packet (transport block), a code block, a codeword, etc. or may be a processing unit of scheduling, link adaptation, etc. When the TTI is given, a time interval (e.g., the number of symbols) to which a transport block, a code block, a codeword, or the like is actually mapped may be shorter than the TTI.

Note that, when one slot or one mini slot is referred to as a “TTI,” one or more TTIs (that is, one or multiple slots or one or more mini slots) may be the minimum time unit of scheduling. Also, the number of slots (the number of mini slots) to constitute this minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

Note that a long TTI (for example, a normal TTI, a subframe, etc.) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

Also, an RB may include one or more symbols in the time domain, and may be one slot, one mini slot, one subframe or one TTI in length. One TTI, one subframe, etc. may each be comprised of one or more resource blocks.

Note that one or more RBs may be referred to as a physical resource block (PRB), a sub-carrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE may not assume to transmit or receive a predetermined channel/signal outside the active BWP. Note that “cell”, “carrier”, etc. in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, etc. described in the present disclosure may be represented using absolute values, or may be represented using relative values with respect to predetermined values, or may be represented using other corresponding information. For example, a radio resource may be specified by a predetermined index.

The names used for parameters etc. in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, etc. described in the present disclosure may be represented using any of a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Information, signals, etc. can be output in at least one of a direction from a higher layer to a lower layer or a direction from a lower layer to a higher layer. Information, signals and so on may be input and output via a plurality of network nodes.

The information, signals and so on that are input and/or output may be stored in a specific location (for example, in a memory), or may be managed in a control table. The information, signals, and the like to be input and output can be overwritten, updated, or appended. The output information, signals, and the like may be deleted. The information, signals and so on that are input may be transmitted to other pieces of apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of the MAC signaling may be performed using, for example, an MAC control element (CE).

Also, reporting of predetermined information (for example, reporting of information to the effect that “X holds”) does not necessarily have to be sent explicitly, and can be sent implicitly (for example, by not reporting this piece of information, by reporting another piece of information, and so on).

Decisions may be made in values represented by one bit (0 or 1), may be made in Boolean values that represent true or false, or may be made by comparing numerical values (for example, comparison against a predetermined value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

The mobile station may be referred to as a subscriber station, mobile unit, subscriber station, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station or the mobile station may be called as a transmitting apparatus, a receiving apparatus, a wireless communication apparatus, and the like. Note that at least one of the base station or the mobile station may be a device mounted on a moving body, a moving body itself, and the like. The moving body may be a transportation (for example, a car, an airplane, or the like), an unmanned moving body (for example, a drone, an autonomous car, or the like), or a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Further, the base station in the present disclosure may be replaced with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be replaced with terms corresponding to communication between terminals (for example, “side”). For example, an uplink channel, a downlink channel, etc. may be replaced with a side channel.

Likewise, a user terminal in the present disclosure may be replaced with a base station. In this case, the base station 10 may have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, the methods described in the present disclosure have presented various step elements using an exemplary order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (3 MB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded on the basis of these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on.”

All references to the elements using designations such as “first” and “second” as used in the present disclosure do not generally limit the amount or sequence of these elements. These designations can be used in the present disclosure, as a convenient way of distinguishing between two or more elements. In this way, reference to the first and second elements does not imply that only two elements may be employed, or that the first element must precede the second element in some way.

The term “determining” as used in the present disclosure may include a wide variety of operations. For example, “determining” may be regarded as “determining” judging, calculating, computing, processing, deriving, investigating, looking up (or searching or inquiring) (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

In addition, “determining” may be replaced with “assuming”, “expecting”, “considering”, or the like.

The terms “connected” and “coupled” used in the present disclosure, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected together, it is conceivable that the two elements are “connected” or “coupled” to each other by using one or more electrical wires, cables, printed electrical connections, and the like, and, as some non-limiting and non-inclusive examples, by using electromagnetic energy having wavelengths in the radio frequency domain, microwave region, or optical (both visible and invisible) region, or the like.

In the present disclosure, the terms “A and B are different” may mean “A and B are different from each other”. Note that the phrase may mean that “A and B are different from C”. The terms such as “separate”, “coupled”, and the like may be interpreted similarly to “different”.

When “include”, “including”, and variations of these are used in the present disclosure, these terms are intended to be inclusive similarly to the term “comprising”. Moreover, the term “or” used in the present disclosure is intended to be not an exclusive-OR.

In the present disclosure, when articles are added by translation, for example, as “a”, “an”, and “the” in English, the present disclosure may include that nouns that follow these articles are plural.

In the above, the invention according to the present disclosure has been described in detail; however, it is obvious to those skilled in the art that the invention according to the present disclosure is not limited to the embodiments described in the present disclosure. The invention according to the present disclosure can be embodied with various corrections and in various modified aspects, without departing from the spirit and scope of the invention defined on the basis of the description of claims. Consequently, the description of the present disclosure is provided only for the purpose of explaining examples, and should by no means be construed to limit the invention according to the present disclosure in any way.

This application is based on Japanese Patent Application No. 2020-139403 filed on Aug. 20, 2020. The contents of this are all incorporated herein.

1. A terminal comprising:
a reception section that receives a configuration indicating an uplink period and a downlink period and receives a slot offset for aperiodic sounding reference signal (SRS) transmission; and
a control section that determines whether or not to receive at least one of a first piece of downlink control information that triggers the SRS transmission and a second piece of downlink control information indicating a slot format.

2. The terminal according to claim 1, wherein, in a case where a higher layer parameter is configured, the control section regards the slot offset as a number of slots available for uplinks.

3. The terminal according to claim 1, wherein the control section assumes that the second piece of downlink control information is not received, and regards the slot offset as a number of slots available for uplinks.

4. The terminal according to claim 1, wherein, on the basis of a reception timing of one of the first piece of downlink control information and the second piece of downlink control information, the control section determines whether or not to receive another of the first piece of downlink control information and the second piece of downlink control information.

5. A radio communication method for a terminal, the radio communication method comprising:
a step of receiving a configuration indicating an uplink period and a downlink period;
a step of receiving a slot offset for aperiodic sounding reference signal (SRS) transmission; and
a step of determining whether or not to receive at least one of a first piece of downlink control information that triggers the SRS transmission and a second piece of downlink control information indicating a slot format.

6. A base station comprising:
a transmission section that transmits a configuration indicating an uplink period and a downlink period and transmits a slot offset for aperiodic sounding reference signal (SRS) transmission; and
a control section that determines whether or not to transmit at least one of a first piece of downlink control information that triggers the SRS transmission and a second piece of downlink control information indicating a slot format.

7. The terminal according to claim 2, wherein the control section assumes that the second piece of downlink control information is not received, and regards the slot offset as a number of slots available for uplinks.

8. The terminal according to claim 2, wherein, on the basis of a reception timing of one of the first piece of downlink control information and the second piece of downlink control information, the control section determines whether or not to receive another of the first piece of downlink control information and the second piece of downlink control information.
